(19) United States
(12) Patent Application Publication
(10) Pub. No.: US 2007/0000147 A1
(43) Pub. Date: Jan. 4, 2007

(54) Sheet feeding device and image forming apparatus

(75) Inventor: Masashi Oyumi, Abiko-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/474,330

(22) Filed: Jun. 26, 2006

(30) Foreign Application Priority Data
Jun. 29, 2005 (JP) 2005-189898

(51) Int. Cl. F26B 21/06

(52) U.S. Cl. 34/535

(57) ABSTRACT

The present invention provides a sheet feeding device comprising: a sheet storage case which stores sheets; a heating reproduction type dehumidification member; moving means which moves the dehumidification member; and a heating reproduction section having heating means which reproduces the dehumidification member by heating, wherein the heating reproduction section is connected to the sheet storage case such that they are separated from each other, the dehumidification member is disposed across the interior of the sheet storage case and the heating reproduction section and moved cyclically between the interior of the sheet storage case and the heating reproduction section by the moving means, and the dehumidification member dehumidified in the interior of the sheet storage case is reproduced by heating by the heating means in the heating reproduction section.

### BACKGROUND OF THE INVENTION

1. Field of the Invention

The present invention relates to a sheet feeding device having a dehumidification function, and an image forming apparatus having the sheet feeding device.

2. Description of the Related Art

When an image forming apparatus such as a copying machine and a printer is left under high humidity environment, recording papers stored in a sheet storage case for storing sheets absorb moisture. The recording papers which absorb moisture in a state in which they are stacked in the sheet storage case can cause sheet feeding failure because they absorb each other. Even if the sheet feeding is possible, likely the transfer characteristic of a toner image worsens so as to produce a defective image in case of an electrophotographic type image forming apparatus because the insulation resistance of a recording paper which absorbs moisture is largely dropped.

Thus, to prevent the sheet feeding failure and production of a defective image resulting from absorption of moisture of the recording paper, a technique for dehumidifying recording papers stored in the storage case has been proposed. For example, Japanese Patent Application Laid-Open No. 8-169582 has proposed a technique for dehumidifying recording papers stored in a sheet storage case using a heater which raises the air temperature in the sheet storage case. Further, Japanese Patent Application Laid-Open No. 9-44063 has proposed a technique for dehumidifying recording papers stored in a sheet storage case using a dehumidification unit containing a chemical absorbent.

However, the technique using the dehumidifying heater has a problem that the sheet storage case is heated although not required because the heater is used within the sheet storage case in order to dehumidify the recording papers. Further, the technique using the chemical absorbent has a problem that the dehumidification unit containing the chemical absorbent needs to be replaced each time when the service life of the chemical absorbent is fulfilled.

Moreover, Japanese Patent Application Laid-Open No. 2005-77762 has proposed air conditioning carried out with air conditioning means connected to an air conditioning object portion such as a sheet feeding cassette through an air passage. This air conditioning means includes one using a heating reproduction type dehumidifying member and another using a Pertier device. The air conditioning means using the heating reproduction type dehumidifying member dehumidifies by making the dehumidifying member absorb water content and removing the water content from the dehumidifying member with a heater repeatedly. In the air conditioning means using the Pertier device, the Pertier device is sandwiched between a fin unit on the heat absorption side and a fin unit on the heat generation side, water content is condensed with the fin unit on the heat absorption side and removed, and then, heated air is fed out with the fin unit on the heat generation side.

These air conditioning means have a problem that the installation position of the air conditioning means is limited and the image forming apparatus grows in size unavoidably due to configuration of the air conditioning means providing the air conditioning object portion and air conditioning means separately in the sheet feeding cassette or the like and connecting them through the air passage.

### SUMMARY OF THE INVENTON

Accordingly, an object of the present invention is to enable dehumidification in the interior of a sheet storage case without heating the interior of the sheet storage case when it is not necessary and replacing a dehumidification member.

To achieve the above-described object, the present invention provides a sheet feeding device including: a sheet storage case which stores sheets; a heating reproduction type dehumidification member; moving means which moves the dehumidification member; and a heating reproduction section having heating means which reproduces the dehumidification member by heating, wherein the heating reproduction section is connected to the sheet storage case such that they are separated from each other, the dehumidification member is disposed over the interior of the sheet storage case and the heating reproduction section and moved cyclically between the interior of the sheet storage case and the heating reproduction section by the moving means, and the dehumidification member dehumidified in the interior of the sheet storage case is reproduced by heating through the heating means in the heating reproduction section.

### BRIEF DESCRIPTION OF THE DRAWINGS

FIG. 1 is a structure sectional view of major portions of a sheet feeding device of a first embodiment.

FIG. 2 is a structure top view of the major portions of the sheet feeding device of the first embodiment;

FIG. 3 is a pattern sectional view showing the schematic structure of an image forming apparatus according to the first embodiment.

FIG. 4 is a flowchart of a dehumidification operation sequence according to the first embodiment.

FIG. 5 is a structure drawing of major portions of a printer control portion according to the first embodiment.

FIG. 6 is a structure sectional view of major portions of a sheet feeding device according to a second embodiment.

FIG. 7 is a structure top view of the major portions of the sheet feeding device according to the second embodiment.

FIG. 8 is a flowchart of a dehumidification operation sequence according to the second embodiment.

FIG. 9 is a structure drawing of the major portions of the printer control portion according to the first embodiment.

### DESCRIPTION OF THE EMBODIMENTS

Hereinafter, preferred embodiments of the present invention will be described in detail with reference to the accompanying drawings.

### First Embodiment

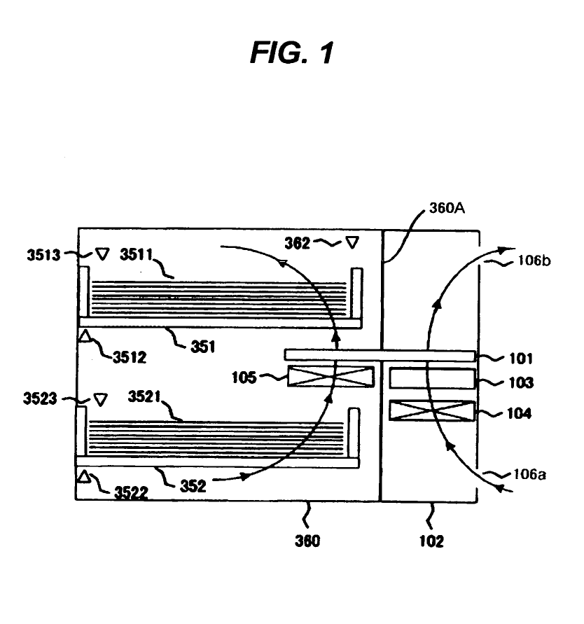

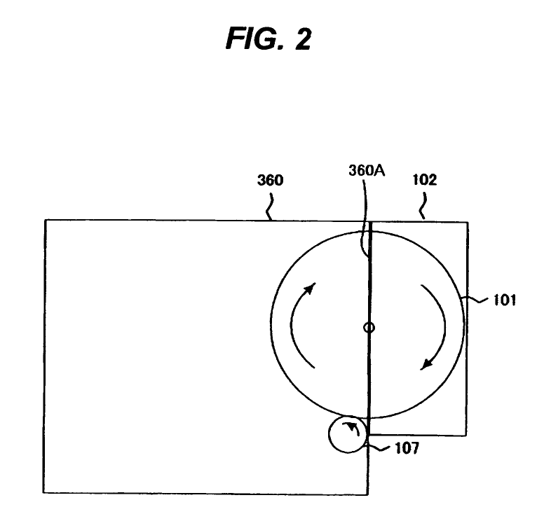

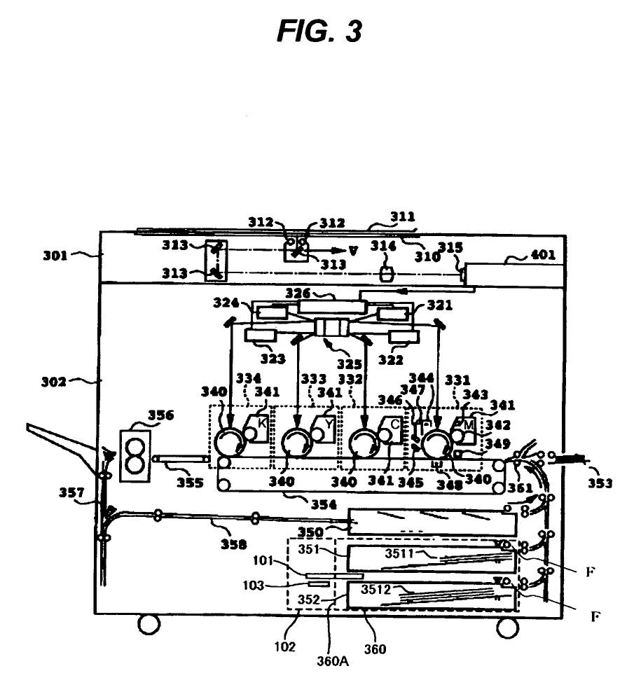

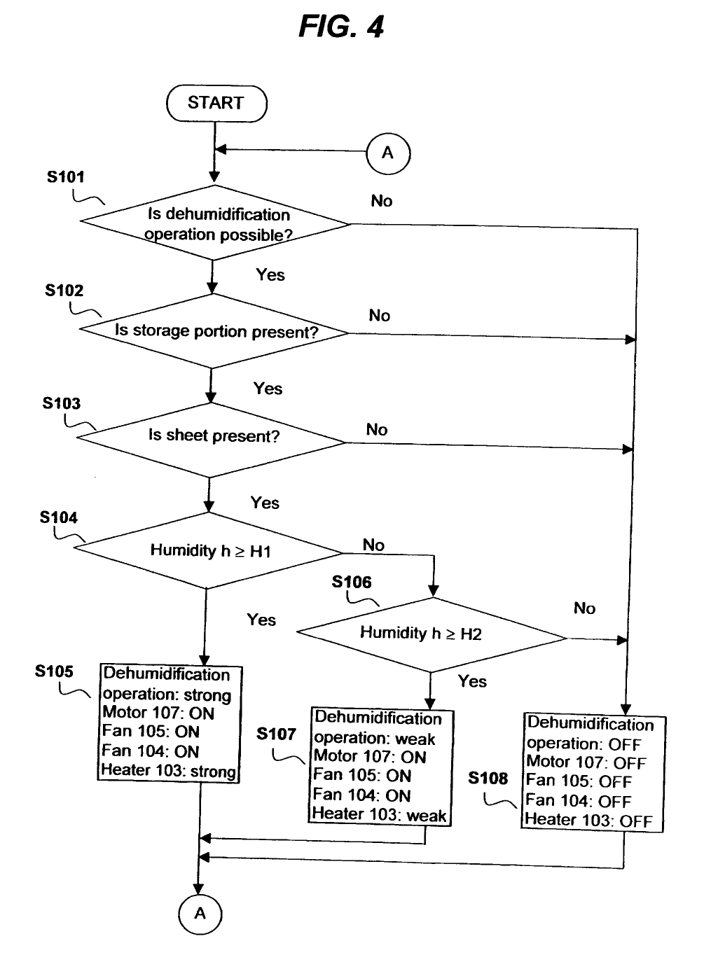

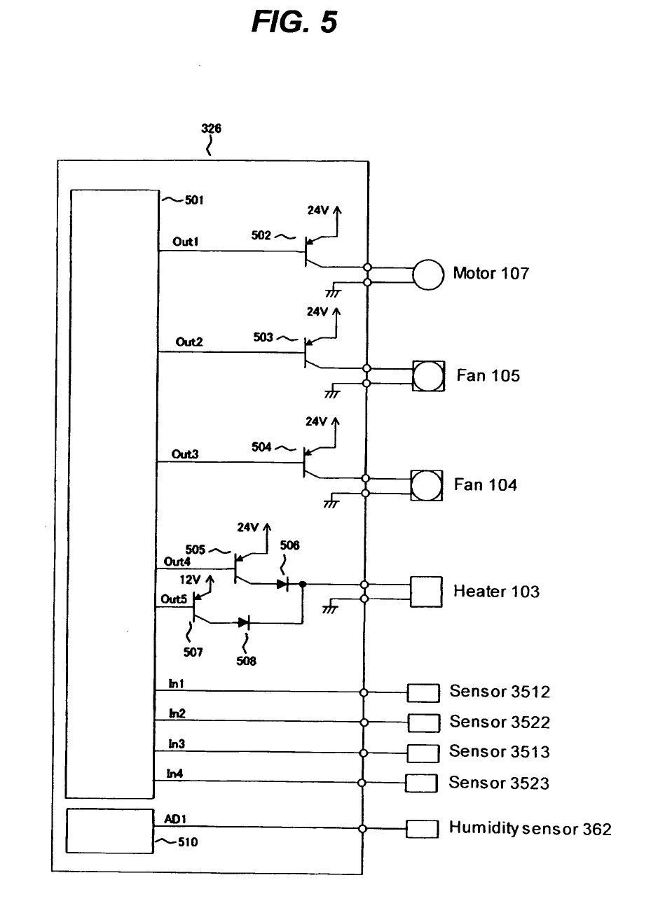

An image forming apparatus having a sheet feeding device according to a first embodiment will be described with reference to FIGS. 1 to 5. FIG. 1 is a structure sectional view of major portions of the sheet feeding device of the first embodiment. FIG. 2 is a structure top view of the major portions of the sheet feeding device of the first embodiment. FIG. 3 is a pattern sectional view showing the schematic structure of an image forming apparatus according to the first embodiment. FIG. 4 is a flowchart of a dehumidification operation sequence according to the first embodiment. FIG. 5 is a structure drawing of major portions of a printer control portion according to the first embodiment.

First, the schematic structure of the image forming apparatus of this embodiment will be described with reference to FIG. 3. As shown in FIG. 3, the image forming apparatus has a reader portion 301 as an image reading portion for reading an image of an original and a printer portion 302 as an image recording portion for recording an image on a sheet.

The reader portion 301 scans the original set between on an original base plate 310 and an original pressing plate 311 in the direction of an arrow V while irradiating with a lamp 312. A reflection light image from the original is focused on a CCD 315 loaded with filters of RBG three colors through a mirror group 313, and a lens 314 and photoelectrically converted to signals of each color of RGB by the CCD 315. An image signal after converted to an electric signal undergoes a predetermined image processing in an image processing portion 401 so as to produce CMYK output image data, and the image data is sent to a printer control portion 326 of the printer portion 302. The printer control portion 326 executes image control and drive control. Reference numeral 325 denotes a polygon scanner for scanning laser beam on each photosensitive drum 340. Reference numerals 331, 332, 333, and 334 denote image forming portions formagenta (M), cyan (C), yellow (Y) and black (K), respectively.

Image conversion processing with predetermined γ correction is applied to image data by the printer control portion 326. Laser beams from laser devices 321, 322, 323, and 324 driven independently depending on image data subjected to the Y correction are projected onto the photosensitive drum 340 of each color. Since the structures of the image forming portions 331, 332, 333, and 334 are the same for the respective colors, here, the image formation device 331 of magenta (M) will be described as a representation of these colors. In the image formation device 331, reference numeral 340 denotes a photosensitive drum for forming a latent image by exposing to laser beam. Reference numeral 341 denotes a development device for developing a toner image on the photosensitive drum 340. Reference numeral 342 denotes a development sleeve for developing the toner image by applying development bias. Reference numeral 343 denotes a toner density sensor for detecting the toner density according to the light quantity from toner (developer) on the development sleeve 342. Reference numeral 344 denotes a primary charger for charging the photosensitive drum 340 with a desired potential. Reference numeral 345 denotes a cleaner for cleaning the surface of the photosensitive drum 340 an image is transferred. Reference numeral 346 denotes an auxiliary charger which neutralizes the surface of the photosensitive drum 340 after cleaned with the cleaner 345 for the primary charger 344 to be able to obtain excellent charging. Reference numeral 347 denotes a pre-exposure lamp for erasing residual charge on the photosensitive drum 340. Reference numeral 348 denotes a transfer charger which transfers a toner image on the photosensitive drum 340 to a sheet by discharging from inside of the transfer belt 354. Reference numeral 349 denotes a development density sensor for detecting the reflection light quantity from an image formed on the photosensitive drum 340.

On the other hand, sheets 3511, 3521 such as recording papers are fed one by one selectively by a sheet feeding portion F having a sheet feeding roller and separation means from sheet storage portions 351, 352. Reference numeral 361 denotes a resistration roller which stops the sheet in a moment so as to determine a conveyance timing of the sheet to the image formation portion. After the conveyance timing is determined by the resistration roller 361, the sheet is sent onto a transfer belt 354. Then, the toner image formed on the photosensitive drum is transferred to a sheet conveyed by the transfer belt 354, so that a magenta image is formed on the sheet. This electrophotographic process is executed on each image formation device for cyan, yellow and black, so that superimposed toner images of respective colors are formed on the sheet. The sheet having the image formed thereon passes through a pre-fixing conveyor 355 and the toner image is heated and fixed by a fixing device 356 so as to form a color image corresponding to the original on the sheet. If rear face discharge with an image surface reversed is carried out, the sheet is conveyed to a reversal conveying path 357, and after the sheet is reversed by there versal conveying path 357, it is discharged. In a mode for forming images on both surfaces, a sheet having an image fixed on one side thereof is conveyed to a re-feeding conveyance path 358 from the reversion conveyance path 357 and then sent into a re-feeding device 350. The sheet sent into the re-feeding device 350 is re-fed to the resistration roller 361 so as to form an image on the other surface, and the above-described image forming operation is carried out in the same manner. Reference numeral 353 denotes a manual sheet feeding device. Here, reference numeral 360 denotes a sheet storage case including the sheet storage portions 351, 352 and the sheet storage portions 351, 352, are detachable. The sheet storage case 360 is substantially closed when the sheet storage portions 351, 352 are inserted properly, although it has an opening portion for a sheet fed to the image formation device from the sheet storage portions 351, 352 by the sheet feeding portion F to pass through.

FIG. 1 shows the structure of the major portions of the sheet feeding device of this embodiment. This is a representation of the sheet storage case 360 of the present invention within the image forming apparatus and a heating reproduction duct 102 as a heating reproduction section of the present invention disposed adjacent to the sheet storage case. The sheet storage case 360 is in a closed state except an opening portion for sheet feeding. Further, the heating reproduction duct 102 as a heating reproduction section is in a closed state except opening portions 106a, 106b which serve as an air entrance/exit. The sheet storage case 360 and the heating reproduction duct 102 are blocked from each other by a partition wall 360A (this may be a sheath of the image forming apparatus). That is, the heating reproduction duct 102 is separated from the sheet storage case 360 which is an interior of the apparatus.

In FIG. 1, reference numeral 101 denotes a heating reproduction type dehumidification member which is formed in a disc shape. Reference numeral 103 denotes a heater as heating means for heating the dehumidification member 101 for its reproduction. Reference numeral 104 denotes a fan as air blowing means for feeding air into the dehumidification member 101 and is disposed within the heating reproduction duct 102. Reference numerals 106a, 106b each denote an opening portion which serves as an entrance/exit of air to/from the heating reproduction duct 102. Reference numeral 105 denotes a fan as a air blowing means for feeding air into the dehumidification member 101 and is disposed within the sheet storage case 360.

Reference numerals 3512, 3522 denote attachment/detachment detection sensors as storage portion detecting means for detecting whether or not the sheet storage portions 351, 352 are present. Reference numerals 3513, 3523 denote a sheet presence/absence detection sensors for detecting the presence/absence of a sheet within the sheet storage case 360. Reference numeral 362 denotes a humidity sensor as a humidity detecting means for detecting the humidity within the apparatus. These sensors 3512, 3522, 3513, 3523, and 362 are disposed within the sheet storage case 360.

The heating reproduction type dehumidification member 101 is disposed across the sheet storage case 360 and the heating reproduction duct 102 separated from the sheet storage case 360. That is, the dehumidification member 101 is so constructed that part thereof is disposed on the side of the sheet storage case 360 across the partition wall 360A while the other part thereof is disposed on the side of the heat reproduction duct 120. The heating reproduction type dehumidification member 101 is constituted of a porous material such as zeolite and has a characteristic of absorbing water content under an air environment containing water content and discharging the absorbed water content under a high temperature environment.

FIG. 2 shows a representation of the sheet storage case 360 within the apparatus and the heating reproduction duct 102 disposed adjacent thereto as seen from above. Reference numeral 107 denotes a motor as moving means for driving the heating reproduction type dehumidification member 101. The heating reproduction type dehumidification member 101 is formed in a disc shape and rotated by the motor 107, so that it moves cyclically between the sheet storage case 360 and the heating reproduction duct 102.

When dehumidification operation is carried out, the heating reproduction type dehumidification member 101 is rotated around its axis by the motor 107. Within the substantially closed sheet storage case 360, air flow indicated by an arrow is produced as if air is spouted against the heating reproduction type dehumidification member 101 in which the fan 105 is rotated. As a result, water content contained in the air in the sheet storage case 360 can be absorbed by the heating reproduction type dehumidification member 101. The heating reproduction type dehumidification member 101 which absorbs water content is moved cyclically to the side of the heating reproduction duct 102 by a rotation. In the area of the heating reproduction type duct 102, the fan 104 creates air flow indicated by an arrow as if air is spouted against the rotating heating reproduction type dehumidification member 101. In the heating reproduction duct 102, air sucked from the opening portion 106a by the fan 104 is heated through the heater 103 and this heated air is spouted against the rotating heating reproduction type dehumidification member 101. Water content is discharged from the dehumidification member 101 absorbing water content by this heated air. Hot air containing much water content passing the dehumidification member 101 is discharged out of the device through the opening portion 106b. The dehumidification member 10l which can absorb moisture again with water content discharged is moved cyclically to the side of the sheet storage case 360 by a rotation, in which the dehumidification member 101 executes absorption operation for water content in the sheet storage case 360. By repeating this cyclic move, dehumidification within the sheet storage case 360 is enabled without replacing the dehumidification member 101. At this time, the efficiency of dehumidification is intensified because the interior of the sheet storage case 360 is dehumidified in a substantially closed state. Further, because the heating reproduction of the dehumidification member 101 is executed in the heating reproduction duct 102 separated from the interior of the device, the interior of the device is never unnecessarily heated by heat used for the heating reproduction, so that the dehumidification within the device can be executed effectively.

The structure diagram of the printer control portion 326 which achieves a dehumidification operation sequence in the image forming apparatus of this embodiment is shown in FIG. 5. Reference numeral 326 denotes a printer control portion for executing image control and drive control of the image forming apparatus. Reference numeral 501 denotes an I/O port 510 connected to a CPU which controls the image forming apparatus, and reference numeral 510 denotes an A/D converter connected to the CPU which controls the image forming apparatus. Reference numerals 502, 503, 504, 505, and 507 denote transistors and reference numerals 506, 508 denote diodes. The attachment/detachment detection sensors 3512, 3522 of the sheet storage portion and the sheet absence/presence detection sensors 3513, 3523 are inputted to the I/O port 501 respectively. The humidity sensor 362 is inputted to the A/D converter 510, so that an analog value outputted corresponding to the humidity is converted to digital value which is sequentially processable (detected humidity).

The flowchart of the dehumidification operation sequence in the image forming apparatus of this embodiment is shown in FIG. 4.

The operation of the printer control portion of FIG. 5 will be described along with the flowchart. The dehumidification operation sequence determines whether or not dehumidification is possible (S101). This is a determination on whether the portion is in a low power mode or operation mode for printing or the like which disables the dehumidification operation with a heater because the portion needs to control power. Unless the portion is not on such an operation mode, it determines that the dehumidification operation is possible.

Next, it is determined whether or not the sheet storage portion is present (S102). If the inputs In1, In2 from the attachment/detachment detection sensors 3512, 3522 indicate presence of the sheet storage portion, the procedure proceeds to next determination. Next, it is determined whether or not any sheet is present (S103). If any of the inputs In3, In4 from the presence/absence detection sensors 3513, 3523 indicate presence of the sheet, the procedure proceeds to next determination.

Next, it is determined whether or not detected humidity h is first set humidity H1 or more (S104). If the humidity h detected based on an A/D value from the humidity sensor 362 is the first humidity H1 set preliminarily or more, it is determined that the humidity within the sheet storage case is high and a strong dehumidification operation is performed (S105). At this time, Out1=L level, Out2=L level, and Out3=L level are outputted, and the motor 107 and the fans 105, 104 are turned ON. Then, Out4=L level, and Out5=H level are outputted to drive the heater 103 at 24 V to execute a strong heating operation.

Next, it is determined whether the detected humidity h is the first set humidity H1 or less (S104) and, then it is determined whether the detected humidity h is not less than a second set humidity H2 which is lower than the first set humidity (S106). At this time, if the humidity h detected based on the A/D value from the humidity sensor 362 is not less than the second humidity H2 set preliminarily, the system determines that the humidity within the sheet storage case is medium and carries out a weak dehumidification operation (S107). At this time, Out1=L level, Out2=L level, and Out3=L level are outputted, and the motor 107 and the fans 105, 104 are turned ON. Then Out4=H level and Out5=L level are outputted to drive the heater 103 at 12 V to carry out a weak heating operation.

If the detected humidity h is the second set humidity H2 or less (S106), the dehumidification operation is stopped (S108). If the dehumidification operation is impossible under the condition of S101, the dehumidification operation is stopped or canceled (S108). Further, if the sheet storage portion is absent under the condition of S102 or the sheet is absent under the condition of S103 also, the dehumidification operation is stopped or canceled (S108). At this time, Out1=H level, Out2 =H level, Out3=H level, Out4=H level, and Out5=H level are outputted, and the motor 107, the fans 105, 104 and the heater 103 are turned off. The dehumidification operation by the heating reproduction type dehumidification member 101 can be controlled depending on the state of the apparatus by such a sequence and a control circuit enables this sequence.

According to this embodiment, as described above, the dehumidification operation within the device is carried out using the heating reproduction type dehumidification member 101, and heating reproduction of the dehumidification member 101 is executed by the heating reproduction duct 102 separated from the interior of the device. As a consequence, it never happens that the interior of the device is heated by heat for the heating reproduction although not required, and further, the interior of the device can be dehumidified effectively without replacement of the dehumidification member 101.

Further, the heating reproduction duct 102 is disposed adjacent to the sheet storage case 360, and the dehumidification member 101 is disposed so as to be moved cyclically between the sheet storage case 360 and the heating reproduction duct 102. As a consequence, the mechanism for achieving dehumidification can be reduced, and there is few limitations about arrangement position of the dehumidification mechanism and further, enlargement of the image forming apparatus can be suppressed.

By configuring the sheet storage case 360 in the substantially closed state, the dehumidification within the device can be carried out effectively when the dehumidification operation is stopped as well as when the dehumidification operation is being done with the motor 107, the heater 103 and the fans 104, 105.

Further, by actuating the fans 104, 105 disposed in the sheet storage case 360 and the heating reproduction duct 102 respectively, along with the motor 107 and the heater 103 at the time of the dehumidification operation, the dehumidification can be executed more effectively.

### Second Embodiment

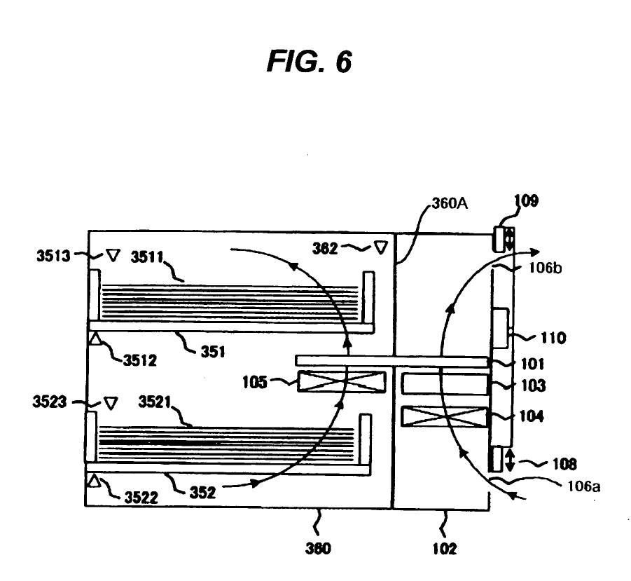

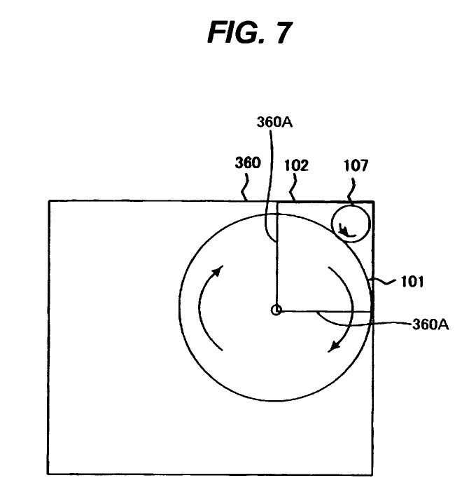

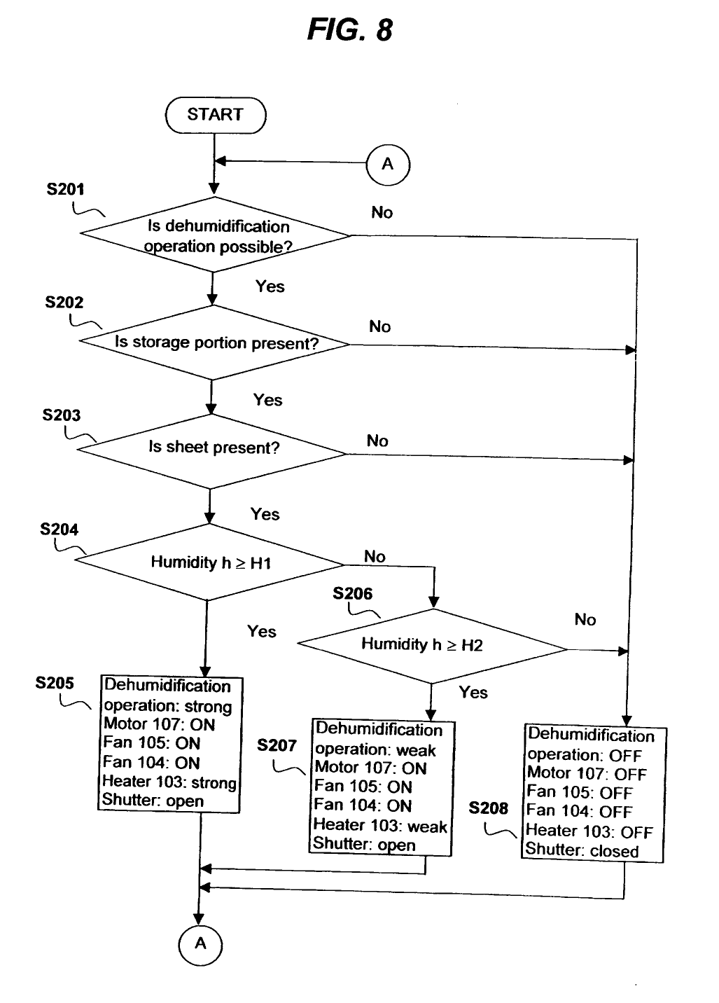

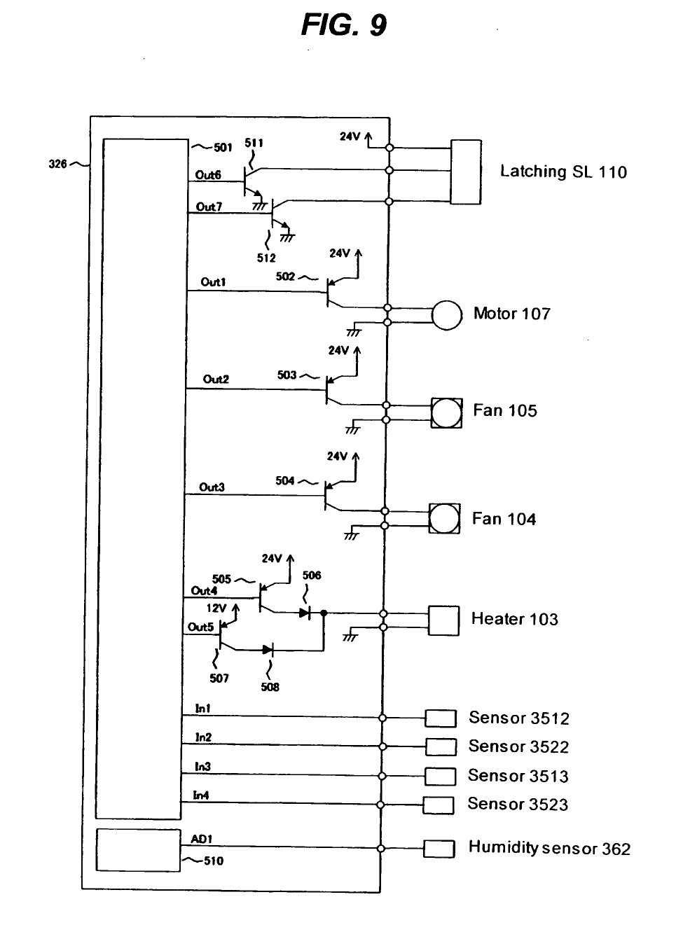

An image forming apparatus having a sheet feeding device according to a second embodiment will be described with reference to FIGS. 6 to 9. FIG. 6 is a structure sectional view of major portions of the sheet feeding device according to the second embodiment. FIG. 7 is a structure top view of the major portions of the sheet feeding device of the second embodiment. FIG. 8 is a flowchart of a dehumidification operation sequence of the second embodiment. FIG. 9 is a structure diagram of major portions of a printer control portion of the second embodiment.

According to this embodiment, the heating reproduction duct 102 is so configured to enable closing in addition to the structure of the above-described embodiment, and the heating reproduction duct 102 is closed when the heater 103, the motor 107 and the fans 104, 105 are inactive. Moreover, the heating reproduction duct 102 separated from the interior of the device is configured into a size which can be accommodated in a second area smaller than a first area of the dehumidification member 101 disposed within the device. Because the other structures are substantially the same as the above-described embodiment, a detailed description thereof will not be described herein.

FIG. 7 is a view showing the sheet storage case 360 within the image forming apparatus and the heating reproduction duct 102 disposed adjacent thereto as seen from above. According to this embodiment, the heating reproduction duct 102 is configured into a size which can be accommodated in the second area (¼) smaller than the first area ( 3/4 ) disposed within the dehumidification member 101. If the heating reproduction duct 102 is accommodated in the ¼ area of the heating reproduction type dehumidification member 101 as shown in FIG. 7, it can be disposed at the corner of the image forming apparatus or the sheet storage case, thereby contributing to reduction of the area occupied by the device. Further, the motor 107 may be disposed on the side of the heating reproduction duct 102 as shown in FIG. 7.

FIG. 6 shows a side view of the sheet storage case 360 within the image forming apparatus and the heating reproduction duct 102 disposed adjacent thereto. Reference numerals 108, 109 denote shutters for opening/closing the opening portions 106a, 106b of the heating reproduction duct 102, and reference numeral 110 denotes a drive portion for driving the shutters 108, 109. Because the other structures are the same as the first embodiment, a detailed description thereof will not be described with the same reference numerals attached to those.

FIG.9 shows a structure diagram of the printer control portion which enables the sequence of the dehumidification operation in the image forming apparatus. Reference numerals 511, 512 denote transistors which drive a latching solenoid 110 as a drive portion. Because the other structures are the same as the first embodiment, a detailed description thereof will not be described with the same reference numerals attached to those.

FIG. 8 shows a flowchart of the sequence of the dehumidification operation in the image forming apparatus of this embodiment. The operation of the printer control portion of FIG. 9 will be described with reference to the flowchart.

In the sequence of the dehumidification operation, first, whether or not the dehumidification operation is possible is determined (S201). This is adetermination on whether the device is in a low power mode or operation mode for print operation or the like which disables the dehumidification operation by turning on the heater because the device needs to limit its power. Unless the above-described operation mode is selected, it is determined that the dehumidification operation is possible.

Next, whether or not the sheet storage portion is present is determined (S202). If both the inputs In1, In2 from the attachment/detachment detection sensors 3512, 3522 indicate the presence of the sheet storage portion, the procedure proceeds to next determination. It is determined whether or not any sheet is present (S203). If any of the inputs In3, In4 from the presence/absence detection sensors 3513, 3523 indicate the presence of the sheet, the procedure proceeds to next determination.

Next, it is determined whether the detected humidity h is the first set humidity H1 or more (S204). If the humidity h detected based on the A/D value from the humidity sensor 362 is the first humidity Hl set preliminarily or more, it is determined that the humidity in the sheet storage case is high and a strong dehumidification operation is carried out (S205). At this time, the state is returned to the L level by applying Out6=H level for a predetermined time interval, and the latching solenoid 110 is actuated with Out7=L level to open the shutters 108, 109. Further, Out1=L level, Out2=L level, and Out3 =L level are outputted, and the motor 107 and the fans 105, 104 are turned on. The heater 103 is driven at 24 V by outputting Out4 =L level and Out5=H level so as to execute a strong heating operation.

Next, it is determined whether the detected humidity h is the first set humidity H1 or less (S204) and then, it is determined whether the detected humidity h is not less than the second set humidity H2 lower than the first set humidity (S206). At this time, if the humidity h detected based on the A/D value from the humidity sensor 362 is not less than the second humidity H2 set preliminarily, it is determined that the humidity in the sheet storage case is medium and a weak dehumidification operation is carried out (S207). At this time, the state is returned to L level by applying Out6=H level for a predetermined time interval, and the latching solenoid 110 is actuated with Out7=L level so as to open the shutters 108, 109. Further, Out1=L level, Out2=L level, and Out3=L level are outputted to turn on the motor 107 and the fans 105, 104. Then, the heater 103 is driven at 12 V by outputting Out4=H level and Out5=L level to carry out a weak heating operation.

If the detected humidity h is the second set humidity H2 or less (S106),the dehumidification operation is stopped (S208). If the dehumidification operation is impossible under the condition of S201, the dehumidification operation is stopped or canceled (S208). Further, if the sheet storage portion is absent under the condition of S202 and the sheet is absent under the condition of S103 also, the dehumidification operation is stopped or the dehumidification operation is canceled (S208). At this time, the state is returned to L level by applying Out7=H level for a predetermined time interval, and the latching solenoid 110 is actuated with Out6=L level to close the shutters 108, 109. Further, by outputting Out1=H level, Out2=H level, Out3=H level, Out4=H level, and Out5=H level, the motor 107, the fans 105, 104 and the heater 103 are turned off. The dehumidification operation using the heating reproduction type dehumidification member 101 can be controlled depending on the condition of the apparatus by such a sequence and a control circuit enables this sequence.

According to this embodiment also, as described above, dehumidification operation for the interior of the device is carried out using the heating reproduction type dehumidification member 101, and the heating reproduction of the dehumidification member 101 is carried out by the heating reproduction duct 102 separated from the interior of the device. As a consequence, it never happens that the interior of the device is heated by heat for the heating reproduction although not required, and the dehumidification of the interior of the device can be carried out effectively without replacement of the dehumidification member 101.

According to this embodiment, not only the sheet storage case 360 is constructed in a substantially closed state but also a shutter operation is executed for closing the opening portions 106a, 106b in the heating reproduction duct 102. Consequently, dehumidification in the interior of the device can be carried out when the dehumidification operation is stopped, and the dehumidified state by the dehumidification operation can be maintained even in a state not consuming power.

### Other Embodiment

Although in the above-described embodiments, the dehumidification operation is controlled based on respective sensor information on presence/absence of the sheet storage portion, presence/absence of sheets and the humidity of the sheet storage case, the input information is not restricted to such information as long as it is information for detecting the state of a portion intended to be dehumidified.

In the above-described embodiments, switching of voltage applied to the heater is exemplified as switching between the strong and weak dehumidification operations. However, the present invention is not restricted to this example but combining with control of the air volume with a voltage applied to, for example, the fan can also obtain the same effect. Further, although the heater is driven with DC voltage and switching of the voltage applied to the heater is exemplified by switching of the DC voltage, the present invention is not restricted thereto. For example, the drive with the DC voltage can be achieved by duty control by PWM drive or controlling the quantity of plural heaters for use. If AC voltage is applied to the heater, the same effect can be obtained by switching between full-wave drive and half-wave drive or switching wave number control.

In the above-described embodiments, a structure for switching between the strong and weak dehumidification operations by two-stage switching of heating temperature of the heater is exemplified. However, the present invention is not restricted to this example, but the switching between the strong and weak dehumidification operations may be executed through multiple stages. Alternatively, switching whether or not the dehumidification operation is carried out instead of switching of the intensity of the dehumidification operation is permissible. Further, it is permissible to control the motor to change the rotation speed of the dehumidification member 101 with the heater heating temperature not changed.

Although in the above-described embodiments, the structure of dehumidifying the sheet storage case 360 by attaching the heating reproduction duct 102 to the sheet storage case 360 has been exemplified, the present invention is not restricted thereto. Any heating reproduction case may be used as long as it is separated from the interior of the device, and for example, it is permissible to attach the heating reproduction duct 102 to the image forming apparatus main body and control dehumidification of the image forming apparatus main body as described in the above-described embodiments.

Further, although in the second embodiment above, the size which can be accommodated in the ¼ area of the dehumidification member 101 is exemplified as the size of the heating reproduction duct 102, the present invention is not restricted thereto. The heating reproduction duct may be in any size as long as it can be accommodated in the second area smaller than the first area disposed within the interiorof the dehumidification member 101.

Although in the embodiments above, the copying machine is exemplified as the image forming apparatus, the present invention is not restricted thereto, but it may be other image forming apparatuses such as a printer, a facsimile or a complex machine combining these functions. The same effect can be obtained by applying the present invention to such an image forming apparatus or a sheet feeding device in the image forming apparatus.

Although in the embodiments above, the sheet feeding device included in the image forming apparatus is exemplified, the present invention is not restricted thereto. For example, the sheet feeding device may be attachable to and detachable from the image forming apparatus, and the same effect can be obtained by applying the present invention to the sheet feeding device.

This application claims the benefit of priority from the prior Japanese Patent Application No. 2005-189898 filed on Jun. 29, 2005 the entire contents of which are incorporated by reference herein.

What is claimed is:

1. A sheet feeding device comprising:
a sheet storage case which stores sheets;
a heating reproduction type dehumidification member;
moving means which moves the dehumidification member; and
a heating reproduction section having heating means which reproduces the dehumidification member by heating,
wherein the heating reproduction section is connected to the sheet storage case such that they are separated from each other, the dehumidification member is disposed across the interior of the sheet storage case and the heating reproduction section and moved cyclically between the interior of the sheet storage case and the heating reproduction section by the moving means, and the dehumidification member dehumidified in the interior of the sheet storage case is reproduced by heating by the heating means in the heating reproduction section.

2. The sheet feeding device according to claim 1, further comprising humidity detection means which detects the humidity in the interior of the sheet storage case,
wherein when the humidity detected by the humidity detection means exceeds a humidity set preliminarily, the moving means and the heating means are actuated.

3. The sheet feeding device according to claim 1, further comprising humidity detection means which detects the humidity in the interior of the sheet storage case,
wherein the heating intensity of the heating means is changed corresponding to the humidity detected by the humidity detection means.

4. The sheet feeding device according to claim 1, further comprising sheetpresence/absence detectionmeans which detects the presence or absence of sheets in the sheet storage case, wherein the operations of the moving means and the heating means are controlled based on the result of detection by the sheet presence/absence detection means.

5. The sheet feeding device according to claim 1,
wherein air blowing means which blows air to the dehumidification member are disposed in each the interior of the sheet storage case and the heating reproduction section.

6. The sheet feeding device according to claim 1,
wherein the dehumidification member is formed into a disc shape and moved cyclically between the interior of the sheet storage case and the heating reproduction section by rotation.

7. The sheet feeding device according to claim 1,
wherein the heating reproduction section is configured into a size enables to accommodate a second area smaller than a first area disposed within the sheet storage case of the dehumidification member.

8. The sheet feeding device according to claim 1, further comprising a shutter which closes an opening portion which takes air into/out of the heating reproduction section,
wherein, when the moving means and the heating means are stopped, the opening portion is closed by the shutter to seal up the heating reproduction section.

9. The sheet feeding device according to claim 1,
wherein the dehumidification member is composed of a porous material, which absorbs water content under an air environment containing water content and discharges the absorbed water content under a high temperature environment.

10. An image forming apparatus including an image formation device which forms an image on a sheet fed from a sheet feeding means, comprising:
a sheet storage case which stores sheets;
a heating reproduction type dehumidification member;
moving means which moves the dehumidification member; and
a heating reproduction section having heating means which reproduces the dehumidification member by heating,
wherein the heating reproduction section is connected to the sheet storage case such that they are separated from each other, the dehumidification member is disposed across the interior of the sheet storage case and the heating reproduction section and moved cyclically between the interior of the sheet storage case and the heating reproduction section by the moving means, and the dehumidification member dehumidified in the interior of the sheet storage case is reproduced by heating by the heating means in the heating reproduction section.
